(19) United States
(12) Patent Application Publication
(10) Pub. No.: US 2026/0230310 A1
(43) Pub. Date: Aug. 6, 2026

(54) PROVIDING QUANTUM-SAFE COMMUNICATIONS SECURITY OVER AN INSECURE NETWORK

(71) Applicant: Palo Alto Networks, Inc., Santa Clara, CA (US)

(72) Inventors: Songling Han, San Ramon, CA (US); Saurabh Tripathi, San Jose, CA (US); Brinda Raghunatha Bharadwaj, San Jose, CA (US)

(21) Appl. No.: 19/045,877

(22) Filed: Feb. 5, 2025

(51) Int. Cl. H04L 9/08; G06F 7/58; H04L 9/30

(52) U.S. Cl. CPC H04L 9/0852; G06F 7/588; H04L 9/30

(57) ABSTRACT

An initial true random number is generated. A hybrid key pair is generated based on the initial true random number. The hybrid key pair includes a first key pair generated by a quantum-safe cryptographic algorithm and a second key pair generated by a cryptographic algorithm. A system request is provided to an entropy service. The system request includes the hybrid key pair. Quantum entropy data included in a response received from the entropy service is decrypted. The response includes a public key associated with the entropy service. The decrypted encrypted quantum entropy data is utilized for cryptographic operations.

### BACKGROUND OF THE INVENTION

A cryptographic protocol such as Transport Layer Security (TLS) may be utilized by two parties wishing to securely share data across a communications network. To employ these protocols and establish a secure connection, a random number is required. Furthermore, such protocols use encryption methods using the random number to ensure that private information can only be accessed by a sender and the intended recipient.

However, quantum computers, which can solve much more complex mathematical problems much more quickly than regular computers, are advancing in their capabilities. These advanced capabilities will allow them to effectively crack the algorithms used in traditional encryption methods. Therefore, classical encryption protocols like TLS may soon be vulnerable to attacks by advanced quantum computers.

### BRIEF DESCRIPTION OF THE DRAWINGS

Various embodiments of the invention are disclosed in the following detailed description and the accompanying drawings.

FIG. 1 is a block diagram illustrating an embodiment of a system to provide quantum-safe communication between an entropy service and two client devices.

FIG. 2 is a flow diagram illustrating a process in which a client device receives quantum entropy information from an entropy service.

FIG. 3 is a flow diagram illustrating a process in which an entropy service provides quantum entropy information to a client device.

FIG. 4 illustrates an example of a quantum-safe protocol for sharing information between a client and an entropy service.

FIG. 5 provides an example of the request provided by a client device to an entropy service.

FIG. 6 provides an example of the response provided by an entropy service to a client device.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Systems and methods of providing quantum-safe communications security over an insecure network are disclosed. As quantum computers advance, they will develop the capabilities to break traditional encryption algorithms and render protocols such as TLS vulnerable to attack. To better protect against such attacks, a quantum-safe method for providing random numbers to devices looking to communicate securely is needed. A quantum-safe protocol is further needed to establish a secure connection and share information privately between these devices.

Providing quantum-safe communications security over an insecure network includes a client device and an entropy service. The client device makes a request to an entropy service. The entropy service provides a response to the client device which includes quantum entropy data. The client device is then free to use the quantum entropy data to establish quantum-safe communication with other client devices. The client device may also request additional quantum entropy data from the entropy service and maintain it in local memory.

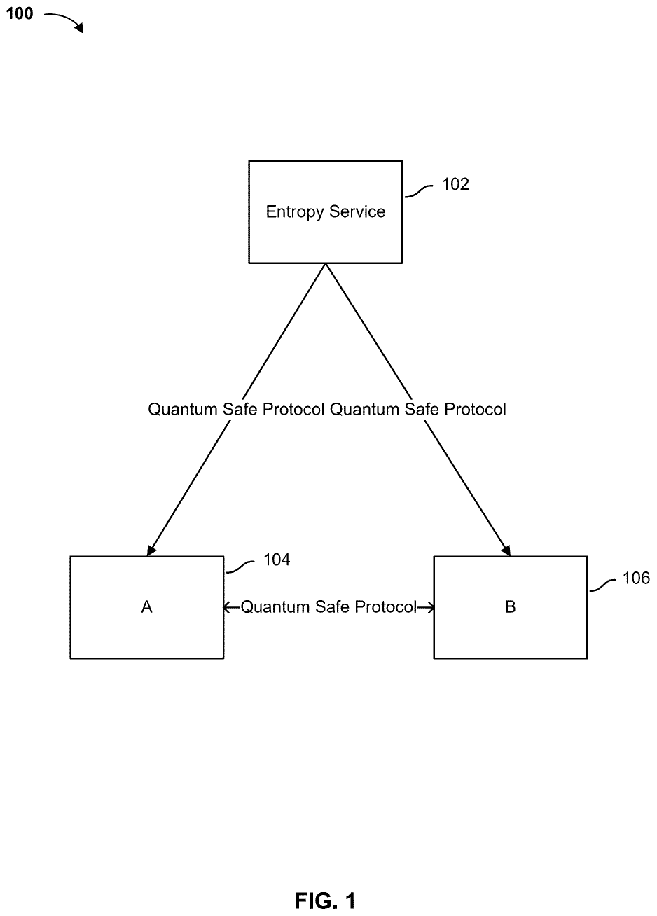

FIG. 1 is a block diagram illustrating an embodiment of a system to provide quantum-safe communication between an entropy service and two client devices.

In the example shown, system 100 includes entropy service 102, client device 104, and client device 106. The entropy service is a server capable of generating quantum random numbers using a Quantum Random Number Generator (QRNG). The QRNG may be part of the entropy service or a third-party vendor.

The client device may be a smartphone, a laptop, a tablet, a firewall, or any other electronic device capable of storing information and communicating with external parties over a network.

The client device (e.g., client device 104 or client device 106) makes a request to entropy service 102. This request includes a public key. The entropy service uses the information provided in the request to encrypt quantum entropy data.

The encrypted quantum entropy data is embedded in a response which is provided back to the client device. The client device uses a corresponding private key to decrypt the quantum entropy data.

The client devices 104, 106 may communicate securely with each other over an insecure network by leveraging the quantum entropy data in a quantum-safe protocol. The client devices 104, 106 may also make subsequent requests to receive additional quantum entropy data from the entropy service and maintain it in local memory.

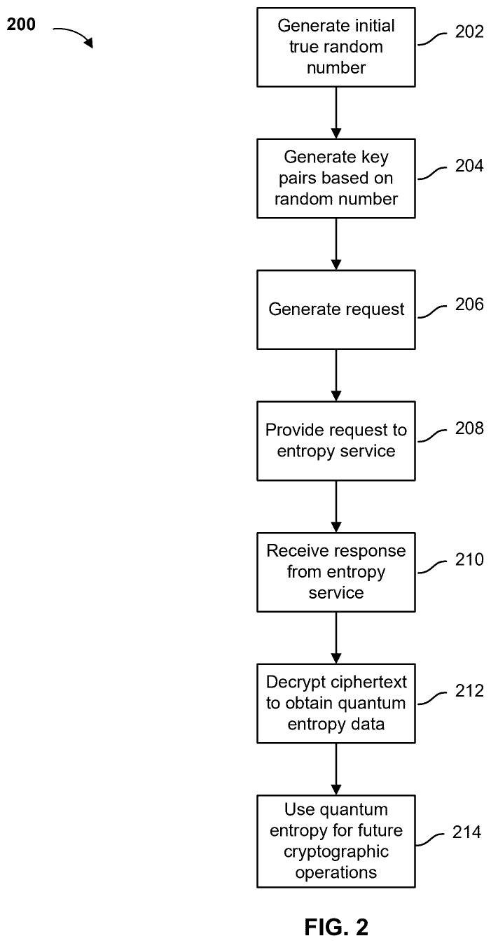

FIG. 2 is a flow diagram illustrating a process in which a client device receives quantum entropy information from an entropy service. In the example shown, process 200 may be implemented by a client device, such as client 104 or client device 106. In some embodiments, the client device is a firewall.

At 202, an initial true random number is generated. In some embodiments, the random number is generated by a local random number generator such as /dev/random. The random number generator may generate random numbers using entropy sources like mouse movements, keyboard clicks, or other noise from the system environment.

At 204, key pairs based on the random number are generated. The random number generated at 202 is used as the seed for the key pair generation process. Each key pair is made up of a public key designed to be shared through network communications as well as a private key that is designed to be kept secret and stored by the client device.

In some embodiments, a hybrid key pair is generated. A hybrid key pair includes two distinct key pairs. One key pair is generated by a quantum-safe cryptographic algorithm, such as Kyber768, and one key pair is generated by a traditional cryptographic algorithm, such as X25519. The use of a hybrid quantum key exchange algorithm throughout this process ensures that the connection between the client and the entropy service is secured against potential threats from quantum computers.

At 206, a system request is generated. In some embodiments, the request is an HTTP GET request in JSON format. The request contains the public keys generated at 204.

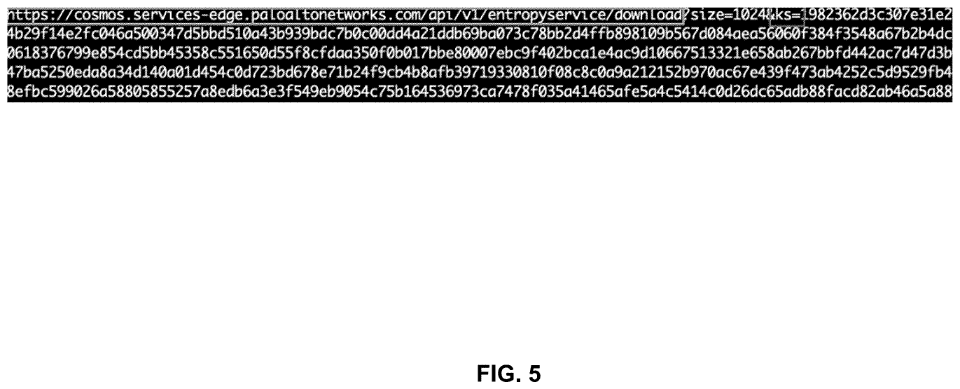

An example of the HTTP GET request in JSON format is provided in FIG. 5. The request contains an API endpoint associated with the entropy service, the request size, and the client's public keys embedded within the ‘ks’ field.

At 208, the request is provided to an entropy service, such as entropy service 102.

At 210, a response is received from the entropy service. In some embodiments, the response is in JSON format. The response contains encrypted quantum entropy data, also referred to as ciphertext, and the entropy service's public key. The response may contain other necessary information such as the initialization vector (IV) and the nonce used for encryption by the entropy service and an encryption tag, like an AEAD authentication tag, to ensure integrity.

At 212, the client uses its private key generated in 204 to decrypt the ciphertext received in the response and obtain the quantum entropy data from the entropy service. In some embodiments, the client uses the private key generated by a quantum algorithm such as Kyber768.

At 214, the client device uses the decrypted quantum entropy data for future cryptographic operations. Such cryptographic operations may include, but are not limited to, evaluating IPSec tunnels, establishing quantum-safe TLS tunnel, or providing quantum-safe random numbers to another device in a network.

Process 200 may be repeated one or more times to fetch additional quantum-safe random numbers from the entropy service. In some embodiments, the quantum-safe random numbers are stored in memory such as a cache or local storage. In subsequent repetitions, the random number generated at 202 is one of the stored quant-safe random numbers generated by the entropy service rather than the initial true random number generated by the client.

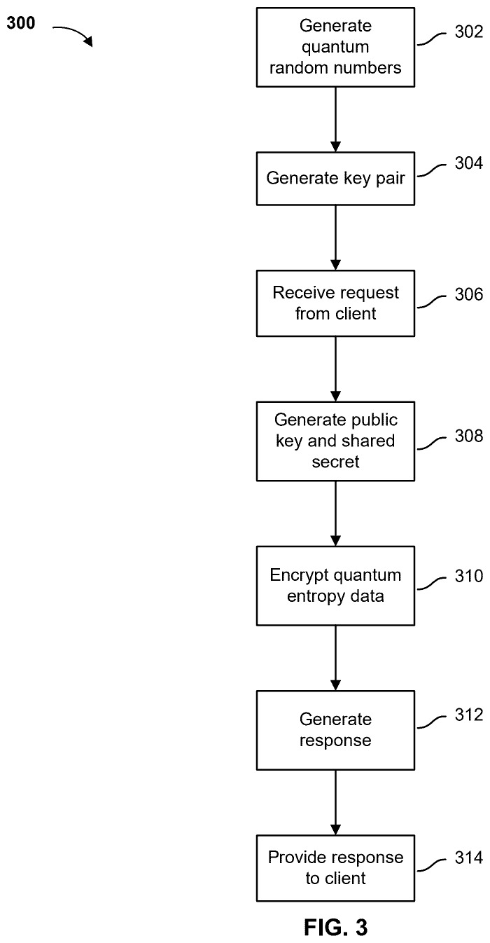

FIG. 3 is a flow diagram illustrating a process in which an entropy service provides quantum entropy information to a client device. In the example shown, process 300 may be implemented by an entropy service such as entropy service 102.

At 302, quantum random numbers are generated. The entropy service may use a Quantum Random Number Generator (QRNG) to generate the quantum random numbers.

At 304, the entropy service generates a key pair using one of the quantum random numbers as the seed. The key pair is made up of a public key designed to be shared through network communications as well as a private key that is designed to be kept secret and stored by the client device. In some embodiments, the key pair is generated by a traditional cryptographic algorithm such as X25519.

At 306, a request is received from a client device. In some embodiments, the request is an HTTP GET request. The request may contain the client device's public keys, where one public key is created using a traditional cryptographic algorithm such as X25519 and the other public key is generated by a quantum-safe cryptographic algorithm such as Kyber768.

At 308, the entropy service generates another public key and a shared secret. In some embodiments, the public key is generated using a quantum-safe cryptographic algorithm such as Kyber768 with a quantum random number (e.g., one of the quantum random numbers produced at 302) as the seed.

In some embodiments, the shared secret is created using the private key generated by the entropy service at 304 and a public key provided by the client request. The client's public key which is used for the shared secret is the one generated by a traditional cryptographic algorithm such as X 25519 (e.g., one of the public keys generated by the client at 204).

At 310, the shared secret along with a cryptographic algorithm like AES (Advanced Encryption Standard) is used to encrypt quantum entropy data, producing ciphertext. In some embodiments, the encryption process also produces an initialization vector (IV) and nonce used for the encryption as well as an encryption tag like an AEAD (Authentication Encryption and Associated Data) authentication tag to ensure integrity.

At 312, a response is generated by the entropy service. In some embodiments, the response is in JSON format. The response contains encrypted quantum entropy data, also referred to as ciphertext, and the entropy service's public key. The response may contain other necessary information such as the IV, the nonce and encryption tag from 310.

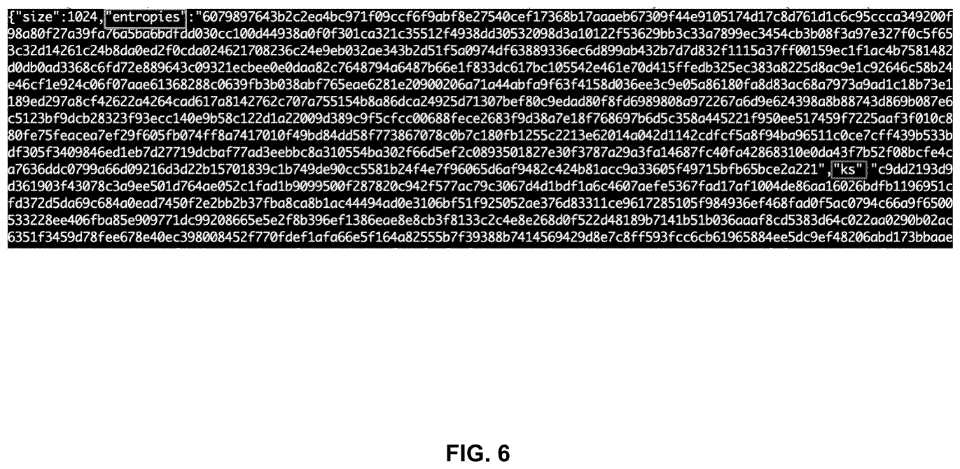

An example of the response in JSON format is provided in FIG. 6. The response contains the size, the encrypted quantum entropies data in the ‘entropies’ field, the entropy service's public key in the ‘ks’ field, and the IV, nonce, and encryption tag appended to the end of the public key in the ‘ks’ field.

At 314, the response is provided to the client.

Processes 200 and 300 leverage the strengths of traditional cryptographic algorithms like X25519 and post-quantum cryptographic algorithms like Kyber768 to create a secure channel that is designed to be resistant to both classical and quantum computational attacks. By using true and quantum random numbers, it ensures a high level of entropy in key generation and cryptographic operations, significantly increasing the protocol's overall security.

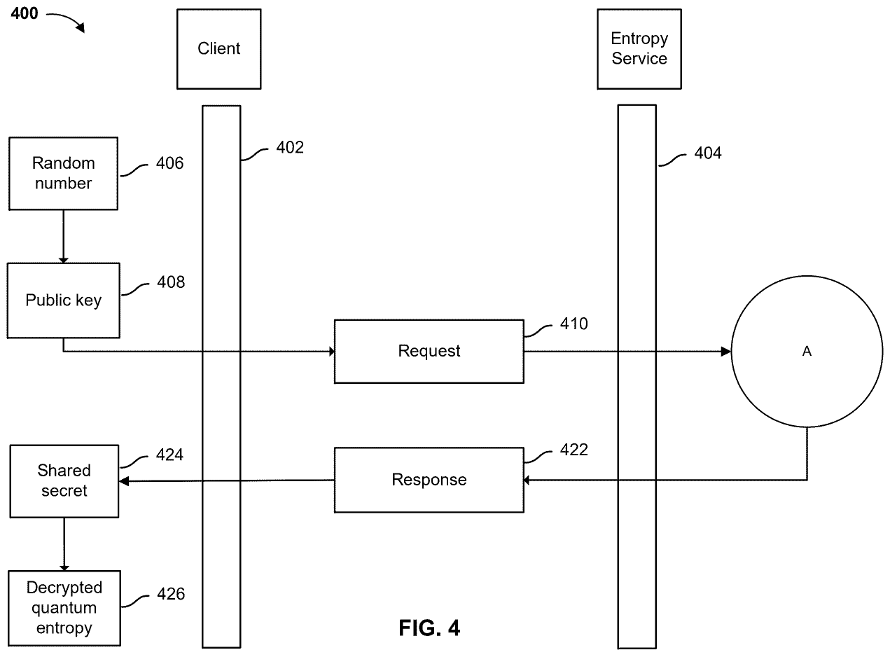

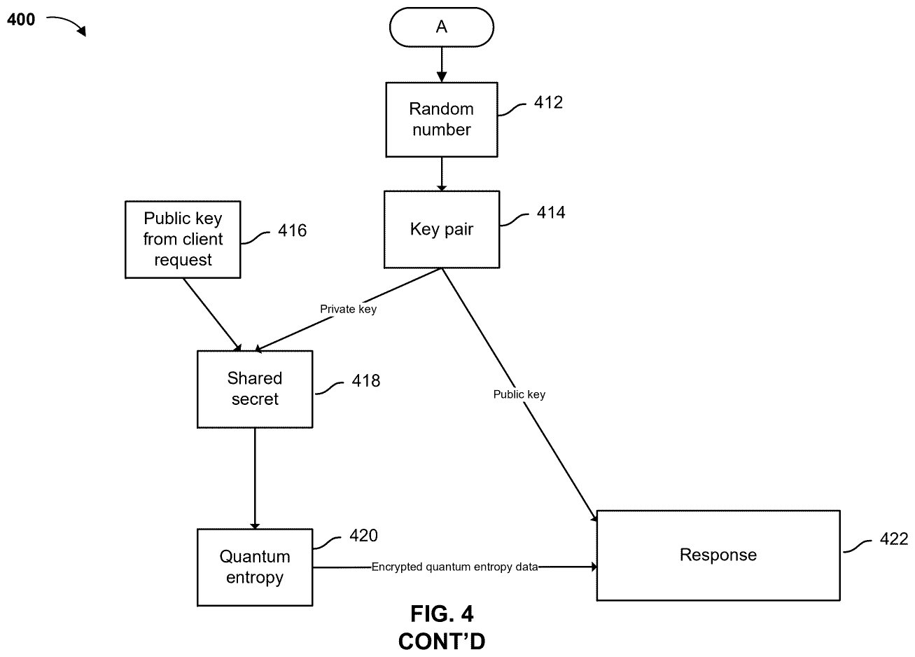

FIG. 4 illustrates an example of a quantum-safe protocol for sharing information between a client device and an entropy service.

In the example shown, system 400 includes client device 402 and entropy service 404. The client device may be a smartphone, a laptop, a tablet, a firewall, or any other electronic device capable of storing information and communicating with external parties over a network.

The entropy service is a server capable of generating quantum random numbers using a Quantum Random Number Generator (QRNG). The QRNG may be part of the entropy service or a third-party vendor.

At 406, an initial true random number is generated. In some embodiments, the random number is generated by a local random number generator such as /dev/random. The random number generator may generate random numbers using entropy sources like mouse movements, keyboard clicks, or other noise from the system environment.

At 408, a hybrid key pair is generated. A hybrid key pair includes two distinct key pairs. One key pair is generated by a quantum-safe cryptographic algorithm, such as Kyber768, and one key pair is generated by a traditional cryptographic algorithm, such as X25519. The use of a hybrid quantum key exchange algorithm throughout this process ensures that the connection between the client and the entropy service is secured against potential threats from quantum computers.

At 410, a system request is generated and provided to the entropy service. In some embodiments, the request is an HTTP GET request in JSON format. The request contains the public keys generated at 204.

An example of the HTTP GET request in JSON format is provided in FIG. 5. The request contains an API endpoint associated with the entropy service, the request size, and the client's public keys embedded within the ‘ks’ field.

At 412, the entropy service generates quantum random numbers. The entropy service may use a Quantum Random Number Generator (QRNG) to generate the quantum random numbers.

At 414, the entropy service generates a key pair using one of the quantum random numbers as the seed. The key pair is made up of a public key designed to be shared through network communications as well as a private key that is designed to be kept secret and stored by the client device. In some embodiments, the key pair is generated by a traditional cryptographic algorithm such as X25519.

At 416, the entropy service receives the request from the client device and obtains the public keys embedded in the ‘ks’ field of the request.

At 418, a shared secret is created using the private key generated by the entropy service at 414 and one of the public keys provided by the client request. The client's public key which is used for the shared secret is the one generated by a traditional cryptographic algorithm such as X25519.

At 420, the shared secret along with a cryptographic algorithm like AES (Advanced Encryption Standard) is used to encrypt quantum entropy data, producing ciphertext. In some embodiments, the encryption process also produces an initialization vector (IV) and nonce used for the encryption as well as an encryption tag like an AEAD (Authentication Encryption and Associated Data) authentication tag to ensure integrity.

At 422, a response is generated by the entropy service. In some embodiments, the response is in JSON format. The response contains encrypted quantum entropy data, also referred to as ciphertext, and the entropy service's public key. The response may contain other necessary information such as the IV, the nonce and encryption tag from 310.

An example of the response in JSON format is provided in FIG. 6. The response contains the size, the encrypted quantum entropies data in the ‘entropies’ field, the entropy service's public key in the ‘ks’ field, and the IV, nonce, and encryption tag appended to the end of the public key in the ‘ks’ field.

The response is provided to the client device.

At 424, upon receiving the response from the entropy service, the client device decapsulates the shared secret from the ‘ks’ field. The client device may decapsulate the key share using a quantum cryptographic algorithm such as Kyber768 combined with a traditional cryptographic algorithm such as X25519.

The client device uses the decapsulated shared secret to derive the AES (Advanced Encryption Standard) key used by the entropy service to encrypt the quantum entropy data.

At 426, the client device uses the derived AES key, its private key, and the IV and nonce from the response to decrypt the quantum entropy data.

The client device uses the decrypted quantum entropy data for future cryptographic operations. Such cryptographic operations may include, but are not limited to, evaluating IP SEC tunnels, establishing quantum-safe TLS tunnel, or providing quantum-safe random numbers to another device in a network.

The exchange between the client device and the entropy service as illustrated in example 400 may be repeated one or more times to fetch additional quantum-safe random numbers from the entropy service. In some embodiments, the quantum-safe random numbers are stored in memory such as a cache or local storage. In subsequent repetitions, the random number generated by the client device at 406 is one of the stored quant-safe random numbers generated by the entropy service rather than the initial true random number generated by the client.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
generating an initial true random number;
generating a hybrid key pair based on the initial true random number, wherein the hybrid key pair includes a first key pair generated by a quantum-safe cryptographic algorithm and a second key pair generated by a cryptographic algorithm;
providing a system request to an entropy service, wherein the system request includes the hybrid key pair;
decrypting encrypted quantum entropy data included in a response received from the entropy service, wherein the response includes a public key associated with the entropy service; and
utilizing the decrypted encrypted quantum entropy data for cryptographic operations.

2. The method of claim 1, wherein the quantum-safe cryptographic algorithm is Kyber768.

3. The method of claim 1, wherein the cryptographic algorithm is X25519.

4. The method of claim 1, wherein the system request is an HTTP GET request.

5. The method of claim 4, wherein the HTTP GET request is in JSON format.

6. The method of claim 1, wherein the system request includes an applications programming interface (API) endpoint associated with the entropy service, a request size, and public keys associated with the hybrid key pair.

7. The method of claim 1, wherein the cryptographic operations include evaluating IPSec tunnels, establishing a quantum-safe transport layer security (TLS) tunnel, and/or providing quantum-safe random numbers to another device in a network.

8. The method of claim 1, wherein the entropy service generates a plurality of quantum random numbers and generates a key pair using one of the quantum random numbers.

9. The method of claim 8, wherein the key pair generated by the entropy service is generated by a cryptographic algorithm.

10. The method of claim 9, wherein the cryptographic algorithm is X25519.

11. The method of claim 8, wherein the entropy service generates a public key and a shared secret.

12. The method of claim 11, wherein the public key is generated using a quantum-safe cryptographic algorithm with one of the quantum random numbers as a seed.

13. The method of claim 11, wherein the shared secret is generated using a private key of the key pair generated by the entropy service and a public key provided in the system request.

14. The method of claim 11, wherein the entropy service encrypts quantum entropy data using the shared secret and a cryptographic algorithm.

15. The method of claim 14, wherein the entropy service generates the response that includes the encrypted quantum entropy data, the public key generated by the entropy service, an initialization vector, a nonce, and an encryption tag.

16. A system, comprising:
a processor configured to:
generate an initial true random number;
generate a hybrid key pair based on the initial true random number, wherein the hybrid key pair includes a first key pair generated by a quantum-safe cryptographic algorithm and a second key pair generated by a cryptographic algorithm;
provide a system request to an entropy service, wherein the system request includes the hybrid key pair;
decrypt encrypted quantum entropy data included in a response received from the entropy service, wherein the response includes a public key associated with the entropy service; and
utilize the decrypted encrypted quantum entropy data for cryptographic operations; and
a memory coupled to the processor and configured to provide the processor with instructions.

17. The system of claim 16, wherein the quantum-safe cryptographic algorithm is Kyber768.

18. The system of claim 16, wherein the cryptographic algorithm is X25519.

19. The system of claim 16, wherein the system request includes an applications programming interface (API) endpoint associated with the entropy service, a request size, and public keys associated with the hybrid key pair.

20. A computer program product embodied in a non-transitory and comprising computer instructions for:
generating an initial true random number;
generating a hybrid key pair based on the initial true random number, wherein the hybrid key pair includes a first key pair generated by a quantum-safe cryptographic algorithm and a second key pair generated by a cryptographic algorithm;
providing a system request to an entropy service, wherein the system request includes the hybrid key pair;
decrypting encrypted quantum entropy data included in a response received from the entropy service, wherein the response includes a public key associated with the entropy service; and
utilizing the decrypted encrypted quantum entropy data for cryptographic operations.
